(19) United States
(12) Patent Application Publication
(10) Pub. No.: US 2013/0315435 A1
(43) Pub. Date: Nov. 28, 2013

(54) SPEAKER EDGE, METHOD FOR MANUFACTURING SAME AND SPEAKER

(71) Applicants: Masatoshi Sato, Yamagata (JP); Nobuaki Takahashi, Yamagata (JP); Masaru Nakagawa, Yamagata (JP); Teruaki Kaiya, Yamagata (JP); Junichi Sato, Yamagata (JP)

(72) Inventors: Masatoshi Sato, Yamagata (JP); Nobuaki Takahashi, Yamagata (JP); Masaru Nakagawa, Yamagata (JP); Teruaki Kaiya, Yamagata (JP); Junichi Sato, Yamagata (JP)

(73) Assignees: TOHOKU PIONEER CORPORATION, Yamagata (JP); PIONEER CORPORATION, Kanagawa (JP)

(21) Appl. No.: 13/990,721

(22) PCT Filed: Nov. 30, 2010
(86) PCT No.: PCT/JP2010/071407

§ 371 Date: Aug. 8, 2013

(51) Int. Cl. H04R 7/16; H04R 7/02

(52) U.S. Cl. CPC H04R 7/16; H04R 7/02
USPC 381/412; 181/171; 264/257

(57) ABSTRACT

A speaker edge includes a resin layer including a resin member and a fiber layer including a tangled fiber body. A melting temperature of the tangled fiber body is higher than a melting temperature of the resin member. The hardness of the tangled fiber body is lower than the hardness of the resin member.

### FIELD OF THE INVENTION

The present invention relates to a speaker edge, a method for manufacturing the same and a speaker including the speaker edge.

### BACKGROUND OF THE INVENTION

A patent literature 1 as shown below discloses that a supporting member (speaker edge) for elastically supporting a diaphragm for an electro-acoustic transducer is composed of a thermoplastic olefin system elastomer having a two-phase structure in which the micro domain phase of polypropylene is dispersed in the matrix of ethylene-propylene diene methylene linkage rubber.

A patent literature 2 as shown below discloses a speaker edge which is formed by simultaneously molding a foam rubber edge and a cloth material. In the conventional speaker edge, a cloth member is provided on either the upper face or the lower face or both faces, or the inside of a foam rubber edge and the cloth member is impregnated with a resin.
Patent literature 1: Japanese examined patent publication No. 7-101958
Patent literature 2: Japanese unexamined application publication No. 2000-261883

The patent literature 1 discloses a speaker edge which was formed by molding a thermoplastic elastomer sheet into an edge shape.

When using the speaker edge for a subwoofer having a comparatively large caliber, a comparatively thick elastomer sheet is selected.

Generally, a thermoplastic elastomer has low thermal conductivity and it is time-consuming to mold a thermoplastic elastomer sheet having a comparatively thick thermoplastic elastomer, and thus efficient manufacturing may not be achieved. It can be considered to shorten the forming time by raising the temperature of a molding die in order to achieve efficient manufacturing. However, if the temperature of a molding die is too much raised, a part of the face of a sheet can be melted, and therefore it is difficult to raise the temperature of a molding die to a high level that can shorten the molding time.

The patent literature 2 discloses a speaker edge which is provided with a foam rubber layer and a fiber layer (cloth member). Further, the patent literature 2 discloses that the hardness of the speaker edge is increased by laminating a cloth member impregnated with a resin to a foam rubber material. In the speaker edge described in the patent literature 2, the physical property of the speaker edge may be significantly affected by the physical property of a cloth member impregnated with a resin. Therefore, it is difficult to adjust the physical property of a speaker edge by the physical property of a foam rubber material. Meanwhile, in the speaker edge disclosed in the patent literature 2, the fiber layer is impregnated with a resin, and therefore when molding the edge by heating, molding takes too much time as with the speaker edge shown in the patent literature 1.

One or more embodiments of the present invention acquire a desired physical property on the basis of a resin member, to improve productivity by raising heating temperature during molding, and to minimize the physical property of a speaker edge in itself being affected by the physical property of a fiber based member when employing the fiber based member as the material of the speaker edge.

### SUMMARY OF THE INVENTION

In one aspect, the present invention is constituted by at least the following configuration.

A speaker edge includes a resin layer including a resin member and a fiber layer including a tangled fiber body. The melting temperature of the tangled fiber body is higher than the melting temperature of the resin member. The hardness of the tangled fiber body is lower than the hardness of the resin member.

### BRIEF DESCRIPTION OF THE DRAWINGS

FIGS. 1(a)-(c) are views illustrating the cross-sectional structure of a speaker edge according to an embodiment of the present invention.

FIGS. 2(a)-(b) are views illustrating the cross-sectional structure of a speaker edge according to another embodiment of the present invention.

FIGS. 3(a)-(b) are views illustrating a speaker including a speaker edge according to an embodiment of the present invention.

FIGS. 4(a)-(c) are views illustrating another configuration example of a speaker edge according to an embodiment of the present invention.

FIG. 5 is a view illustrating the manufacturing process of a speaker edge according to an embodiment of the present invention.

FIGS. 6(a)-(b) are views illustrating an electronic device and an automobile in which a speaker employing a speaker edge according to the present invention is mounted.

FIGS. 7(a)-(b) are views illustrating electronic devices in which a speaker employing a speaker edge according to the present invention is mounted.

### DETAILED DESCRIPTION OF THE INVENTION

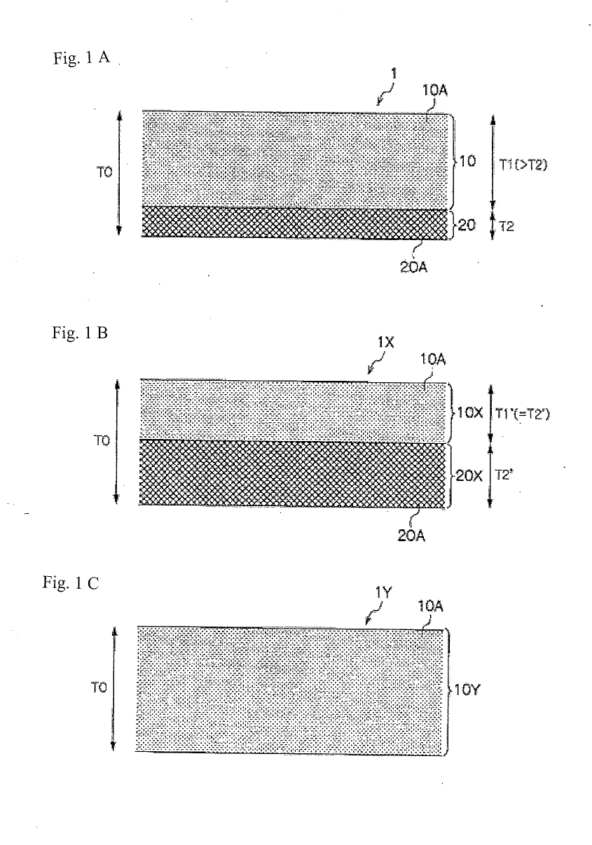

Hereinafter, an embodiment of the present invention is described with reference to drawings. The embodiment of the present invention includes the content shown in the drawings, but is not limited only thereto. FIG. 1 is a view illustrating the cross-sectional structure of a speaker edge according to an embodiment of the present invention.

FIG. 1(a) shows a speaker edge according to an embodiment of the present invention, and FIGS. 1(b) and 1(c) show comparative speaker edges.

A speaker edge 1 is provided with a resin layer 10 and a fiber layer 20. The resin layer 10 is a layer that forms an elastic resin member 10A. The density of the resin layer 10 is substantially the same as that of the resin member 10A. The resin layer 10 forms, for example, unfoamable resin member. The term “unfoamable” means that when a resin member is molded, it does not include additive foaming agent such as a foaming agent and a microcapsule. A fiber 20 is a layer that forms a tangled fiber body 20A including a plurality of fibers that are tangled each other.

The speaker edge 1 has the thickness of T0 and the thickness T2 of the fiber layer 20 is smaller than the thickness T1 of the resin layer 10 (T1>T2). As shown in the example, the sum of the thickness T1 of the resin layer 10 and the thickness T2 of the fiber layer 20 is equivalent to the thickness T0 of the speaker edge 1. Not only the thickness of this example, but also the thickness of layer other than the resin layer 10 and the fiber layer 20 (such as a connecting layer or a layer in which an connecting resin member and a tangled fiber body are mixed, or a connecting layer which are described later) can be included in the thickness T0 of the speaker edge 1.

The constituent material of the resin member 10A mainly comprises a resin material. Further, a filler, an antistatic agent and so forth may be used as the constituent material in addition to the resin material. For example, an elastic thermoplastic resin (thermoplastic elastomer) can be listed as the resin material. The constituent material may be a single resin material or a mixture of a plurality of resin materials. Further, the resin material comprises a copolymer in which two or more kind of high molecules having different chemical structures (skeletons) are chained.

The tangled fiber body 20A includes a configuration having a plurality of fibers that are tangled each other. The tangled fiber body 20A includes a woven fabric and an unwoven fabric. From among a woven fabric and an unwoven fabric as the tangled fiber body, the unwoven fabric may be used as the tangled fiber body in consideration of the fact that for example, the unwoven fabric has comparatively small effect on the formability of the resin member 10A or results in comparatively small deformation over time in the speaker edge after molding. Further, when a woven fabric has elasticity in a direction, the unwoven fabric may be used as the tangled fiber body in consideration of the fact that the unwoven fabric has comparatively small effect on the formability of the resin member 10A or results in comparatively small deformation over time in the speaker edge after molding. Further, as the unwoven fabric, there are an unwoven fabric (bonded tangled body) having a plurality of fibers bonded each other with a bonding resin and a freely tangled unwoven fabric (free type tangled body) in which a plurality of fibers is not bonded each other by means of water jet punching or needle punching. Further, as the unwoven fabric having a bonding resin (bonded unwoven fabric), there are an unwoven fabric (bonded dissimilar material tangled body) that has a different-type bonding resin formed with a resin material different from the constituent material of a fiber, and a self-bonded unwoven fabric (self-bonding type tangled body) in which a plurality of fibers is mutually bonded by specific spinning such as flash spinning or with a thermal bonded fiber. From among a plurality types of unwoven fabrics that is described above, a freely tangled unwoven fabric is used as a tangled fiber body in consideration of the fact that the freely tangled unwoven fabric has comparatively small effect on the formability of the resin member 10A or results in comparatively small deformation over time that is generated in the speaker edge after molding, or the weight of a tangled fiber body constituting a vibrating body (such as diaphragm or edge) is comparatively small.

Additionally, the tangled fiber body 20A may be a form configured by stacking the bonded tangled body and the free type tangled body.

The constituent material of a fiber may be a resin material or a natural material. A synthetic fiber such as a polyester-system fiber, a nylon-system fiber and so forth, a natural fiber (a plant fiber such as cotton, silk and so forth, an animal fiber such as wool, a mineral fiber such as basalt fiber are included), and a glass fiber are listed as a fiber. Further, in view of adjusting the internal loss of a speaker edge, for example, a polyester-system fiber that has small internal loss with respect to the resin member 10A (for example, internal loss is approximately 0.02) may be used as a fiber forming the tangled fiber body 20A. Further, a polyester-system fiber that has a high Young's modulus with respect to the resin member 10A (for example, Yong's modulus is approximately 2.5×10̂9 N/m2) may be used as the tangled fiber body 20A.

The speaker edge 1 may be used even when the melting temperature of the tangled fiber body 20A, particularly the melting temperature of the fiber included in the tangled fiber body 20A is comparatively high. In view of molding the speaker edge 1 according to one or more embodiments, the tangled fiber body 20A, particularly the fiber included in the tangled fiber body 20A is not melted when heating the tangled fiber body 20A at the melting temperature of the resin member 10A. From this view point, the melting temperature of the tangled fiber body 20A, particularly the melting temperature of the fiber included in the tangled fiber body 20A is higher than the melting temperature of the resin member 10A. Further, in view of molding the speaker edge 1 according to one or more embodiments, the melting temperature of the tangled fiber body 20A is higher, for example 30° C. or more, than the melting temperature of the resin member 10A.

In the speaker edge 1, the hardness of the tangled fiber body 20A may be lower than the hardness of the resin member 10A. When hardness is represented by G and Young's modulus is represented by E and thickness is represented by t, then G=Et³ is satisfied.

The hardness of the speaker edge 1 may be lower than the hardness of an edge in which the thickness of the resin layer 10 is the same as the thickness of the fiber layer 20 (the comparative edge having substantially the same thickness: see FIG. 1(b)) among the speaker edges 1.

In the speaker edge 1, the internal loss of the tangled fiber body 20A may be larger than the internal loss of the resin member 10A. Further, the internal loss of the speaker edge 1 having the thickness of T0 may be smaller than the internal loss of an edge which has the thickness of T0 and is formed only by the resin member 10A (first comparative speaker edge: see FIG. 1(c)) and may be larger than the internal loss of the comparative edge (see FIG. 1(b)) which has the thickness of T0 and is formed to have the same thickness for the resin layer 10 and the fiber layer 20.

According to the above-mentioned speaker edge 1, the heating temperature when molding the speaker edge can be increased by providing the fiber layer 20 formed with the tangled fiber body 20A that has comparatively high melting temperature. Further, the molding time of the speaker edge 1 can be shortened so that productivity can be improved. Additionally, the speaker edge is configured such that the physical property of the fiber layer 20 has comparatively small effect on the physical property of the resin layer 10. As such, the physical property of the speaker edge 1 can be properly adjusted by selecting the constituent material of the resin member 10A (by selecting the type of resin materials, the ratio of mixed resin materials or the resin material for a copolymer).

FIG. 1(b) shows the comparative edge 1X (the comparative speaker edge having the same thickness described above) to be compared with the speaker edge 1 according to an embodiment of the present invention. The comparative edge 1X is the same as the speaker edge 1 except that the thicknesses of the resin layer and the fiber layer are different from those of the speaker edge 1. Specifically, the comparative edge 1X is provided with a first layer 10X formed with the same resin member 10A as that of the speaker edge 1 and a second layer 20X formed with the same tangled fiber body 20A as that of the speaker edge 1. The thickness T1 of the resin layer 10 of the speaker edge 1 is larger than the thickness T1′ of the first layer 10X of the comparative edge 1X. The thickness T2 of the fiber layer 20 of the speaker edge 1 is smaller than the thickness T2′ of the second layer 20X of the comparative edge 1X. Further, the thickness T1′ of the first layer 10X of the comparative edge 1X is the same as the thickness T2′ of the second layer 20X (T1′=T2′). Further, the total thickness (T0) of the comparative edge 1X is the same as the thickness (T0) of the speaker edge 1.

FIG. 1(c) shows the comparative edge 1Y (the second comparative speaker edge described above) to be compared with the speaker edge 1 according to an embodiment of the present invention. The comparative edge 1Y is the same as the speaker edge 1 except that the comparative edge 1Y does not have the fiber layer of the speaker edge 1. Specifically, the comparative edge 1Y is provided with only a first layer 10Y formed with the same resin member 10A as that of the speaker edge 1. The thickness T1 of the resin layer 10 of the speaker edge 1 is smaller than the thickness T0 of the first layer 10Y of the comparative edge 1Y. Additionally, the total thickness (T0) of the comparative edge 1Y is the same as the thickness (T0) of the speaker edge 1.

When the speaker edge 1 according to an embodiment of the present invention is compared with the above-mentioned comparative edge 1X (comparative speaker edge having the same thickness), the hardness of the speaker edge 1 may be lower than the hardness of the comparative edge 1X. Further, the internal loss of the speaker edge 1 may be larger than the internal loss of the comparative edge 1X. Further, when the speaker edge 1 is compared with the above-mentioned comparative edge 1Y (the second comparative speaker edge), the hardness of the speaker edge 1 is higher than the hardness of the comparative edge 1Y and the internal loss of the speaker edge 1 is smaller than the internal loss of the comparative edge 1Y.

In the speaker edge 1 according to an embodiment of the present invention, the thickness T1 of the resin layer 10 is larger than the thickness T2 of the fiber layer 20. In particular, the ratio of the thickness of the resin layer 10 to the thickness of the speaker edge 1 is larger than the ratio of the thickness of the first layer 10X to the thickness of the comparative edge 1X. In this situation, the physical property of the speaker edge 1 is mainly set by the physical property of the resin member 10A. In particular, the physical property of the resin member 10A has a larger effect than the physical property of the tangled fiber body 20A on the physical property of the speaker edge 1.

Further, as shown in a Table 1, since the speaker edge 1 is provided with the resin layer 10 and the fiber layer 20, the internal loss of the speaker edge 1 is smaller than the internal loss of the second comparative speaker edge (only resin layer) in low frequencies. Thereby, the mechanical resistance with respect to a vibrating body (diaphragm and edge are included) in low frequency range is comparatively small so that the vibrating body is easily vibrated. When a speaker device including the speaker edge 1 is a speaker device for low frequency reproduction, the speaker edge having small internal loss in low frequency range can be favorably used. Additionally, the reproduced frequency range of the speaker device for low frequency reproduction is not limited to low frequency range and may include low frequency range and intermediate frequency range.

TABLE 1

| | Young's modulus | | Specific modulus E/ |
|---|---|---|---|
| | E [N/m²] | Internal loss | □ [m²/s²] |
| Frequency during | 100 Hz | 100 Hz | 100 Hz |
| measurement | | | |
| Second | 3.29E+07 | 0.118 | 3.66E+04 |
| comparative | | | |
| speaker edge | | | |
| Speaker edge 1a | 6.09E+07 | 0.083 | 7.38E+04 |
| Speaker edge 1b | 6.48E+07 | 0.080 | 8.11E+04 |

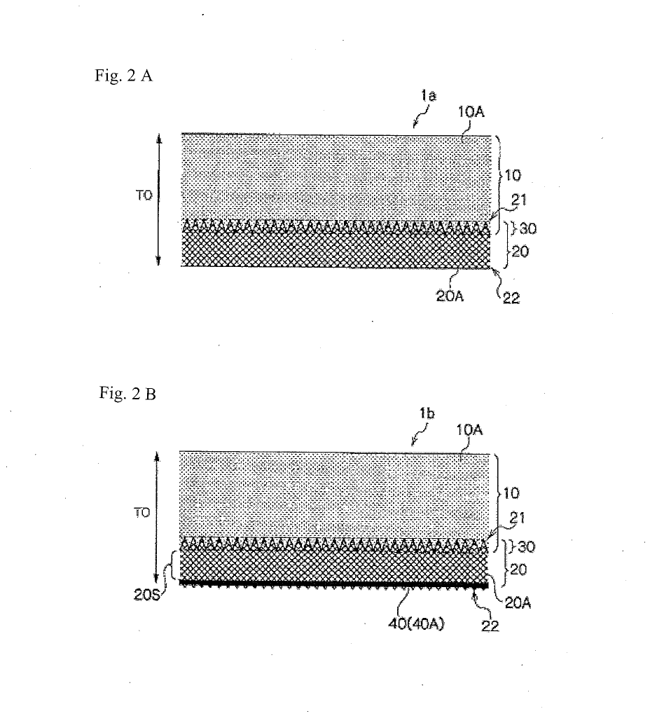

FIG. 2 is a view illustrating the cross-sectional structure of a speaker edge according to another embodiment of the present invention. A speaker edge 1a shown in FIG. 2(a) is provided with a resin layer 10 that is formed with an elastic resin member 10A (for example, unfoamable resin member) and a fiber layer 20 that is formed with a tangled fiber body 20A having a plurality of fibers that are tangled each other. Further, the speaker edge 1a is provided with a connecting layer 30 in which a part of the tangled fiber body 20A arranged on the side of the resin layer 10 and a part of the resin member 10A arranged on the side of the fiber layer 20 are mixed. In the connecting layer 30, the fiber of the tangled fiber body 20A is mixed into the resin member 10A.

According to such a speaker edge 1a, the resin layer 10 and the fiber layer 20 are firmly connected by the connecting layer 30, and thus the fiber layer 20 can deform along with the deform of the resin layer 10. Therefore, it is possible to comparatively decrease an effect that the tangled fiber body 20A has on the formability of the resin member 10A. Further, it is possible to comparatively reduce a deformation over time in the speaker edge after molding. Further, it is possible to shorten the molding time of the speaker edge 1a. Further, by providing the fiber layer 20 that has contact with the resin layer 10, it is possible to efficiently transmit the heat from a heat source during molding to the resin layer 10 through the fiber layer 20. Therefore, the resin layer 10 is easily molded. Further, the fiber layer 20 and the resin layer 10 may be connected by a connecting member that is different from the resin member 10A forming the resin layer 10 (other connecting members). By connecting the resin layer 10 and the fiber layer 20 with other connecting member, if the hardness of the speaker edge 1a is higher than the speaker edge 1a that has the connecting layer, the resin layer 10 and the fiber layer 20 may be connected by providing the connecting layer.

Further, when the temperature of the heat source is raised to a higher temperature than the melting temperature of the resin member 10A, the temperature of the resin member 10A is efficiently raised by thermally contacting the resin member 10A to a molding die as a heat source which is described later via the tangled fiber body 20A, thereby facilitating the molding of the resin layer 10.

The fiber layer 20 is provided with a first face 21 facing the resin layer 10 and a second face 22 on the opposite side of the resin layer 10. Further the fiber layer 20 provided between the connecting layer 30 and the second face 22 is substantially formed the tangled fiber body 20A. Further, the fiber layer 20 provided between the connecting layer 30 and the second face 22 may be composed of a free type tangled body or a tangled fiber body 20A that is a stacking body in which a bonded tangled body and a free type tangled body are stacking.

The tangled fiber body 20A has a space therein, the space being constituted by a plurality of fibers. Further, a part of the fiber layer 20 in the proximity of the second face 22 has a space. Where, the porosity (%) of the tangled fiber body 20A is represented by (1−weight of total fiber included in tangled fiber body (g)/density of fiber (g/m3)/volume occupied by tangled fiber body 20A (m3))×100. The porosity of the tangled fiber body 20A may be greater than the porosity of the resin member 10A. Additionally, recessed and protruding parts are formed on the face of the fiber layer 20 by a plurality of tangled fibers.

The resin member 10A is formed with a thermoplastic resin having elasticity as a resin material. Further, the second face 22 of the fiber layer 20 includes an interface or a attaching face to which a attaching countermember (not shown) is connected directly or through other member. Here, a frame is listed as a attaching countermember. A connecting member such as a bonding agent is listed as other member. The space constituted by a plurality of fibers is provided in the proximity of the interface of the second face 22. This space may communicate with the space of the tangled fiber body 20A that is arranged between the resin layer 10 and the second face 22. When the interface and the attaching countermember are connected via a bonding agent, the bonding agent comes into contact with the recessed and protruding parts included in the interface, thereby the connecting area on the interface is comparatively increased so that the fiber layer 20 can be connected with a comparatively large bonding strength. Further, the bonding agent enters into the space of the interface, thereby connecting the attaching countermember and the fiber layer 20 with a comparatively large bonding strength. Further, when the above-mentioned space in the proximity of the interface communicates with the space of the tangled fiber body 20A, the bonding agent deeply enters into the fiber layer 20, and thus the attaching countermember and the fiber layer 20 are more firmly connected. In particular, there are cases when an elastic thermoplastic resin has a small bonding strength with respect to the attaching countermember and when the bonding strength is increased by applying a face treatment (priming) to the face of the attaching countermember. Even when the bonding strength of an elastic thermoplastic rein with respect to the attaching countermember is comparatively small, since the recessed and protruding parts or space is provided in the proximity of the interface included in the fiber layer 20, it is possible to connect the interface of the speaker edge 1a and the attaching countermember (face) can be connected with a comparatively large bonding strength by using the connecting member regardless of the constituent material of the attaching countermember.

Additionally, the fiber layer 20 has a layer in which the tangled fiber body 20A and the connecting member are mixing in the proximity of the second face 22.

The fiber layer 20 of a speaker edge 1b as shown in FIG. 2(b) is provided with a face layer 40 arranged on the side of the second face 22 and an intermediate layer 20S arranged between the connecting layer 30 and the face layer 40. Further, the face layer 40 is formed with the tangled fiber body 20A and a bonding member 40A bonding a plurality of fibers of the tangled fiber body 20A, and the intermediate layer 20S is formed with the tangled fiber body 20A as a free type tangled body. The face layer 40 may be formed to be thinner than the intermediate layer 20S. In this case, the heat from an external heat source can be efficiently transmitted to the resin layer 10 through the fiber layer.

As shown in Table 1, the hardness of the speaker edge 1b is substantially equal to or higher than the hardness of the speaker edge 1a. Further, the internal loss of the speaker edge 1b is substantially equal to or smaller than the internal loss of the speaker edge 1a.

In the speaker edge 1b, the face layer 40 is formed on the face of the fiber layer 20 of the speaker edge 1a. The face layer 40 has a space and a connecting member connecting a plurality of fibers of the tangled fiber body 20A. A resin member formed with a resin material such as a polyurethane resin is listed as the connecting member. Further, in the face layer 40, the connecting member is provided, for example, in the proximity of a tangled point where a plurality of fibers is tangled. That is, the connecting member constitutes a space which communicates between the outside and the inside of the face layer 40 and/or the fiber layer 20.

The speaker edges 1, 1a, and 1b are molded into a prescribed shape by being heated using a heat source. At this time, one face of the resin layer 10 and one face of the fiber layer 20 act as contact faces that have contact with an external heat source for molding the speaker edges. The fiber layer 20 is a heat transmission layer for transmitting the heat from the external heat source to the resin layer 10.

The resin member 10A may be formed with a thermoplastic resin. The thermoplastic resin can be composed of a copolymer having a hard segment and a soft segment, or a mixture of a first resin member as a hard segment and a second resin member as a soft segment. For example, a polyurethane resin and so forth composed of a polydiol (polyester and so forth) as a soft segment, a hard segment (diisocyanate such as MDI), and a chain extender (ethylene glycol) are listed as the copolymer. A mixture in which mutually different resin materials are mixed is listed as the mixture. For example, the mixture is composed of employing polypropylene (PP) and so forth as the first resin member and employing ethylene-propylene diene terpolymer (EPDM) and so forth as the second resin member. A resin member composed of a resin material (TPO) in which the polypropylene (PP) and the ethylene-propylene diene terpolymer (EPDM) are mixed has a Young's modulus of approximately 3.29*10̂7 and an internal loss of approximately 0.118.

When a thermoplastic resin forming the resin member 10A is a mixture having the first constituent member and the second constituent member, the physical property of the speaker edges 1, 1a and 1b can be properly set by the compounding ratio of the mixture. For example, it is possible to select an edge wherein the internal loss of the first resin member is larger than the internal loss of the second resin member, and the internal loss of the first resin member is larger than the internal loss of a resin material constituting the fiber of the fiber layer 20. By selecting a thermoplastic olefin-system resin as the first resin member and selecting a rubber-system resin as the second resin member, the above-mentioned relationship of the internal loss can be achieved. Polypropylene (PP) can be used as the thermoplastic olefin-system resin that is used as the first resin member. Ethylene-propylene diene terpolymer (EPDM) can be used as the rubber-system resin that is used as the second resin member. And, polyester (for example, polyethylene terephthalate (PET) and so forth) can be used as the constituent material of the fiber constituting the fiber layer 20. The internal loss of the polypropylene (PP) is approximately 0.08 and the internal loss of the ethylene-propylene diene terpolymer (EPDM) is approximately 0.02. And, the internal loss of the polyethylene terephthalate (PET) is approximately 0.02. Additionally, polyurethane resin may be used as the resin material of the resin member 10A.

The specific heat of the resin material (for example, polyethylene terephthalate (PET)) constituting the fiber of the fiber layer 20 may be smaller than the specific heat of the first resin member (for example, polypropylene (PP)) and/or the second resin member (for example, ethylene-propylene diene terpolymer (EPDM)). Specifically, the specific heat (kJ/kg*K) of the polyethylene terephthalate (PET) is 1.05 and the specific heat of the polypropylene (PP) is 1.93. And, the specific heat of the ethylene-propylene diene terpolymer (EPDM) is 2.17. By decreasing the specific heat of the constituent material constituting the fiber of the fiber layer 20, it is possible to raise the temperature of the fiber layer 20 with a comparatively small quantity of heat. Further, it is possible to efficiently mold the resin layer 10 by transmitting thereto a comparatively small quantity of heat through the fiber layer 20.

The resin layer 10 may be formed as a series of layers continuously formed with the resin member 10A. In this case, the face density of the resin layer 10 is larger than the face density of the fiber layer 20. Therefore, it is possible to set the hardness of the speaker edge 1 to be a desired magnitude.

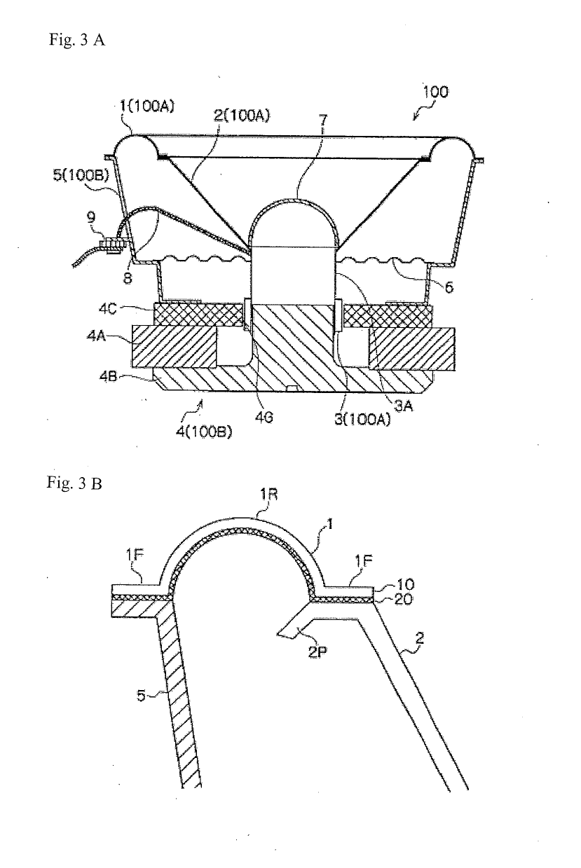

FIG. 3 is a view illustrating a speaker including a speaker edge according to an embodiment of the present invention. FIG. 3(a) shows a cross-sectional structure of a whole speaker and FIG. 3(b) shows a cross-sectional structure of an edge mounting portion.

A speaker 100 is provided with a vibration system member 100A including the speaker edge 1 and a static member 100B that is static with respect to the vibration of the vibration system member. The static member supports the vibration system member 100A. The vibration system member 100A includes a diaphragm 2 and a voice coil 3 vibrating the diaphragm 2. The static member 100B includes a magnetic circuit 4 and a frame 5 (attaching countermember) to which the vibration system member 100A is attached.

In an example shown in the drawing, the voice coil 3 is supported by a voice coil support part (voice coil bobbin) 3A and the voice coil support part 3A is connected to the inner peripheral part of the diaphragm 2. The outer peripheral part of the diaphragm 2 is attached to the frame 5 via the speaker edge 1. Further, the voice coil support part 3A is supported by the frame 5 vibratably through a damper 6.

The magnetic circuit 4 has a magnet 4A, a yoke 4B and a plate 4C, and a magnetic gap 4G is formed between the plate 4C and the yoke 4B. The voice coil 3 that is supported by the voice coil support part 3A is arranged in the magnetic gap 4G. The top portion of the voice coil support part 3A is covered with a center cap 7. Both ends of the voice coil 3 are connected to a terminal portion 9 into which an audio signal is input through a lead wire 8. Additionally, the terminal portion 9 is electrically connected with the outside.

As shown in FIG. 3(b), the one end part of the speaker edge 1 is connected to the outer peripheral part of the diaphragm 2 via a connecting member and the other end part of the speaker edge 1 is connected to the frame 5 (attaching countermember) via a connecting member. The speaker edge 1 can have any shape as long as the shape allows the edge to vibratably support the diaphragm 2 to the frame 5. In an example shown in the drawing, the speaker edge includes a curved part 1R and flat parts F on both sides of the curved part 1R. One flat part 1F is connected to the outer peripheral part of the diaphragm 2 and the other flat part 1F is connected to the flange part of the frame 5.

The speaker edge 1 is arranged such that the fiber layer 20 faces the frame 5 or the diaphragm 2 (attaching countermember). That is, a connecting member such as a bonding agent is applied to the fiber layer 20. In the speaker edge 1a shown in FIG. 2(a), the connecting member is applied to the second face 22 of the fiber layer 20 and the connecting member enters into the space provided in the proximity of the second face so that the connection state between the connecting member and the fiber layer 20 is strengthened.

In the speaker edge 1b shown in FIG. 2(b), the connecting member is applied to the face of the face layer 40. The similar space as the space of the second face 22 of the fiber layer 20 is formed also in the face layer 40, the connecting member enters into the space so that the connection state between the connecting member and the fiber layer 20 is strengthened.

FIG. 3(b) shows the cross-sectional shape of the speaker edge 1 the attaching structure of the speaker edge 1 to the diaphragm 2, and the attaching structure of the speaker edge 1 to the frame 5 (attaching countermember). A turned part 2P is provided at the outer peripheral part of the diaphragm 2. By having the turned part 2P, the diaphragm 2 can improve acoustic characteristic.

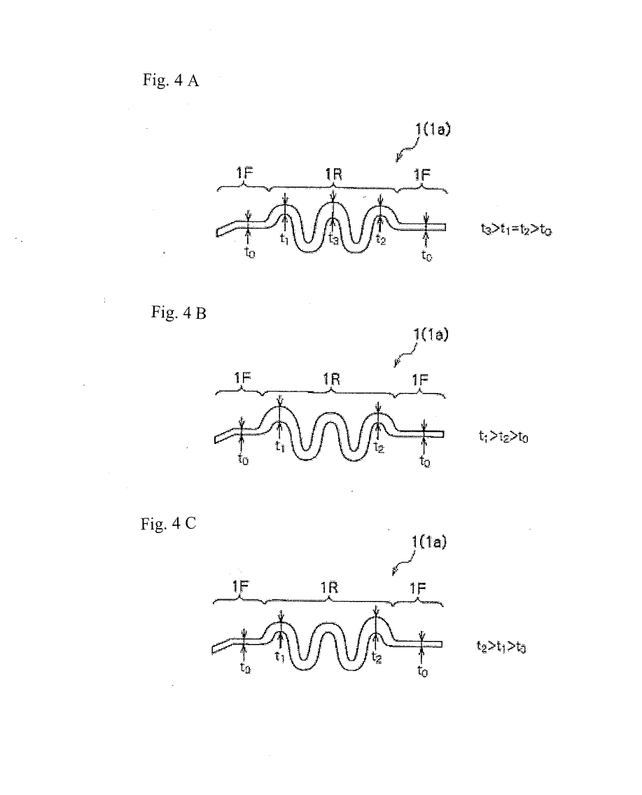

FIG. 4 is a view (cross-sectional view) illustrating another configuration example of a speaker edge according to an embodiment of the present invention. The illustrated speaker edge 1 (1a) has linear portions 1F in the inner and outer sides of the curved portion 1R and the curved portion 1R has a plurality of recessed and protruding parts. FIGS. 4(a), 4(b) and 4(c) show cross-sectional shapes in which the thickness of the edge 1(1a) differs from partially. The speaker edge 1(1a) shown in FIG. 4(a) illustrates an example in which the thickness (t3) of a part between the inner peripheral part and the outer peripheral part is thicker than other part. The speaker edge 1(1a) shown in FIG. 4(b) illustrates an example in which the thickness (t1) of the inner peripheral part is thicker than other part. And, the speaker edge 1(1a) shown in FIG. 4(c) illustrates an example in which the thickness (t2) of the outer peripheral part is thicker than other part. By having such shapes, the speaker edge can minimize the occurrence of cracks and fissures therein. Further, the whole edge can vibrate as a rigid body so that stress is prevented from concentrating on the curved portion. Further, the whole edge can respond to the vibration of the diaphragm as a rigid body, and thus it is possible to minimize the occurrence of division vibration (split resonance included).

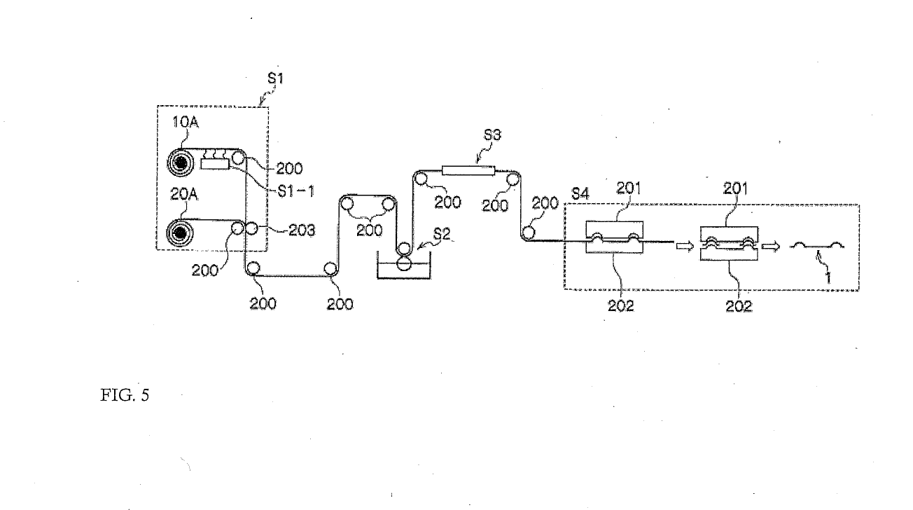

FIG. 5 is a view illustrating the manufacturing process of a speaker edge according to an embodiment of the present invention. In an example shown in the drawing, the manufacturing process of the speaker edge 1 comprises a step of forming a tangled fiber body in which the tangled fiber body 20A is formed as a sheet; a step of forming a resin member in which the resin member 10A is formed as a sheet; and a step of stacking and connecting the sheet-like tangled fiber body 20A and the sheet-like resin member 10A.

In a connecting step S1, the resin member 10A and the tangled fiber body 20A that were formed as sheets and wound in a roll-like fashion are stacked while being transported by a transportation roller 200, and are connected by a pressure roller 203. Heat treatment S1-1 is applied to the resin member 10A before being connected, and then the softened resin member 10A and the tangled fiber body 20A are connected by the pressure roller 203.

A stacking body of the resin member 10A and the tangled fiber body 20A undergoes a step of the application of a surface layer S2 and a drying step S3 while being transported by the transportation roller 200, and then a molding step S4 is applied thereto. Various types of application methods such as gravure coating can be used in the step of the application of the face layer S2.

A stacking body of the resin member 10A and the tangled fiber body 20A is molded into the speaker edge 1 by using a heat source in the molding step S4. In the molding step S4, the stacking body including the resin layer 10 formed with the resin member 10A and the fiber layer 20 formed with the tangled fiber body 20A is inserted between a molding die 201 (second molding die) that is arranged on the side of the resin layer as a heat source and a molding die 202 (first molding die) that is arranged on the side of the fiber layer as a heat source.

Further, in the molding step S4, the molding die 201 is brought into contact with the resin layer 10 and the molding die 202 is brought into contact with the fiber layer 20, and the temperature on the molding die 202 is set to be higher than the temperature of the molding die 201, thereafter the stacking body is molded into an edge shape.

If the melting temperature of the tangled fiber body 20A forming the fiber layer 20 is higher than the melting temperature of the resin member 10A forming resin layer 10, it is possible to set the temperature of the molding die 202 on the side of the fiber layer to be higher than the temperature of the molding die 201 on the side of the resin fiber. The fiber layer 20 is heated by bringing the high-temperature molding die 202 into contact with the fiber layer 20. Thereby, the heat from the molding die 202 is transmitted to the resin layer 10 through the fiber layer 20. Further, the resin layer 10 can be efficiently heated so that shortening the time of molding can be achieved. The temperature of the molding die 202 may be set to be higher than the melting temperature of the resin member 10A and set to be substantially equal to or lower than the melting temperature of the tangled fiber body 20A. After being molded with a heat source, the stacking body is properly cooled down and cut to a prescribed size, and thus the speaker edge 1 is manufactured.

In the embodiments described above, the resin layer 10 is formed with the unfoamable resin member 10A. Not limited to the above example, the resin layer 10 may be formed with a foamable resin member 10A.

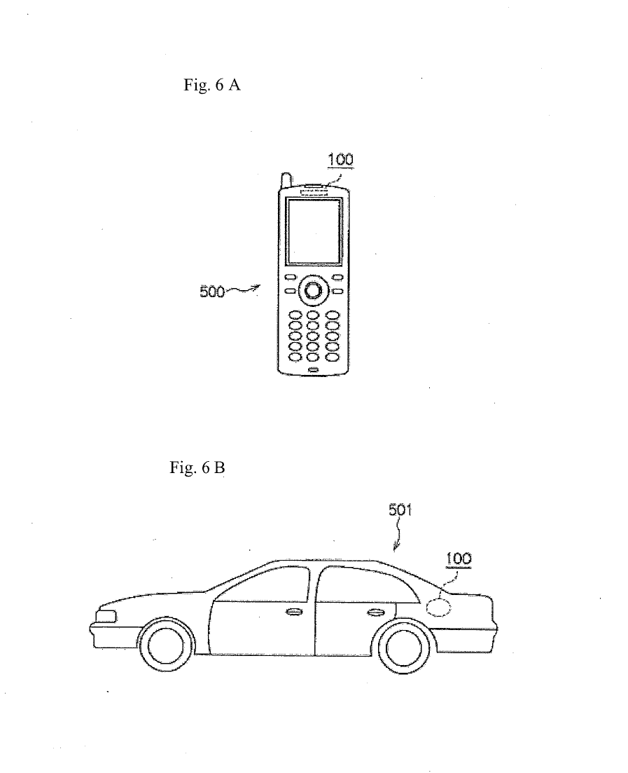

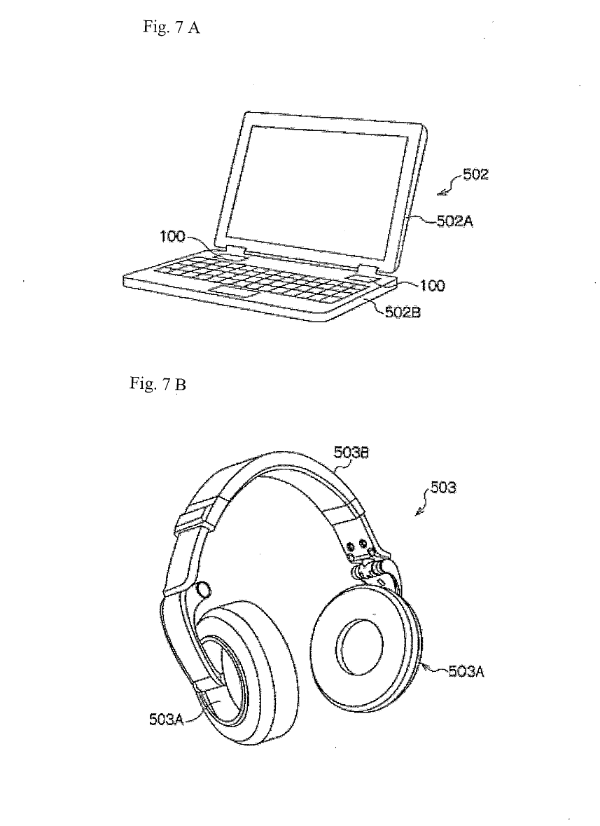

FIG. 6 is a view illustrating an electronic device and an automobile in which a speaker employing a speaker edge according to the present invention is mounted. FIG. 7 is a view illustrating electronic devices in which a speaker employing a speaker edge according to the present invention is mounted. A speaker according to an embodiment of the present invention can be mounted in an electronic device and an automobile as shown in the drawings as well as a building such as a residential house.

A speaker 100 can be accommodated in a housing as a attaching countermember, which is provided for an electronic device 500 such as a mobile phone or a handheld terminal as shown in FIG. 6(a) or a flat panel display. Further, the speaker 100 can be used for an automobile 501 as shown in FIG. 6(b).

An electronic device 502 shown in FIG. 7(a) is a personal computer (portable type, note type, laptop type, etc.) and an electronic device 503 shown in FIG. 7(b) is a headphone.

The electronic device 502 is provided with a display unit 502A and an input operation unit 502B, and the input operation unit 502B is used as a housing for accommodating the speaker 100. The display unit 502A and the input operation unit 502B are rotatably connected. A plurality of the speakers 100 is installed such that the vibrating bodies are arranged on the operating face of the input operation unit 502B. Additionally, not limited to the example shown in the drawing, a single or a plurality of the speakers 100 may be installed on the lateral portion and so forth of the display unit 502A that is used as a housing. The electronic device 503 includes a pair of (a plurality of) housings 503A, 503A that accommodates the speakers 100, and an arch-like connection unit 503B works as a wire housing unit that accommodates a wire for electrically connecting a plurality of the speakers 100.

Although the embodiments according to the present invention have been described with reference to the drawings as described above, it should be understood that specific configurations are not limited to these embodiments, and alterations and modifications not departing from the subject matter of the present invention are included in the scope of the present invention. Further, the embodiments shown in the above-described drawings can be mutually combined. Additionally, it should be understood that the subject matters shown in the respective drawings can be mutually independent embodiments and the embodiments of the present invention are not constructed as a single embodiment that combines the subject matters shown in the respective drawings.

1-29. (canceled)

30. A speaker edge comprising:
a resin layer including a resin member; and
a fiber layer including a tangled fiber body, wherein
a melting temperature of the tangled fiber body is higher than a melting temperature of the resin member, and
a hardness of the tangled fiber body is lower than a hardness of the resin member.

31. The speaker edge according to claim 30, wherein a thickness of the fiber layer is smaller than a thickness of the resin layer.

32. The speaker edge according to claim 30, wherein the fiber layer includes space.

33. The speaker edge according to claim 30, wherein the fiber layer includes the tangled fiber body as a free-type tangled body.

34. The speaker edge according to claim 30, further comprising a connecting layer including a part of the tangled fiber body and a part of the resin member between the fiber layer and the resin layer.

35. The speaker edge according to claim 30, wherein a specific heat of a fiber in the tangled fiber body is substantially equal to or smaller than a specific heat of a resin material in the resin member.

36. A speaker comprising:
a vibration system member having the speaker edge according to claim 30;
a static member supporting the vibration system member, and
a magnetic circuit.

37. The speaker edge according to claim 30, wherein
the vibration system member includes a diaphragm and a voice coil, and
the static member includes the magnetic circuit and an attaching countermember,
the diaphragm is attached to the attaching countermember via the speaker edge.

38. A method for manufacturing a speaker edge comprising:
molding a stacking body into a prescribed shape by heating with a first molding die and a second molding die as heat sources, the stacking body including a resin layer having a resin member and a fiber layer having a tangled fiber body, wherein
a hardness of the tangled fiber body is lower than a hardness of the resin member, and
a melting temperature of the tangled fiber body is higher than a melting temperature of the resin member.

39. The method for manufacturing a speaker edge according to claim 38, wherein
a temperature of the first molding die is higher than a temperature of the second molding die, and
the molding includes contacting the first molding die with the fiber layer and contacting the second molding die with the resin layer.

40. The method for manufacturing a speaker edge according to claim 38, wherein
the fiber layer includes the tangled fiber body as a free-type tangled body, and
a temperature of first molding die is higher than the melting temperature of the resin member and is substantially the same or lower than the melting temperature of the tangled fiber body.

41. The method for manufacturing a speaker edge according to claim 38, wherein a specific heat of the fiber in the tangled fiber body is substantially the same or smaller than a specific heat of the resin material in the resin member.

42. The method for manufacturing a speaker edge according to claim 38, further comprising:
forming the tangled fiber body as a sheet, and
forming the resin member as a sheet, and
stacking and connecting the sheet-like tangled fiber body and the sheet-like resin member.

43. An automobile comprising the speaker device according to claim 30.

44. An electronic device comprising the speaker device according to claim 30.

45. A building comprising the speaker device according to claim 30.
